(19) United States
(12) Patent Application Publication
(10) Pub. No.: US 2012/0152992 A1
(43) Pub. Date: Jun. 21, 2012

(54) TRAVEL CADDY

(76) Inventors: Stacy S. Baas, Oakland, CA (US); Diane L. Stanley, St. Joseph, MO (US)

(21) Appl. No.: 12/972,142

(22) Filed: Dec. 17, 2010

(51) Int. Cl. B60R 7/00; B23P 11/00

(52) U.S. Cl. 224/275; 29/428

(57) ABSTRACT

Embodiments of the present disclosure include a travel caddy having couplers configured to top hook a seatback pocket.

### FIELD

Embodiments of the present disclosure generally relate to the field of personal accessories, and more particularly, to a travel caddy.

### BACKGROUND

Reaching essential items when traveling, either by airplane or vehicle, may be challenging, particularly, when traveling with infants and small children. Current carrying bags are often difficult to reach under an airplane seat or in a vehicle, and needed items are often hard to access within deep carry-on bags. Further, the current space constraints of airplanes requires making use of the seat-back pocket for one's belongings, where they are easily lost and cleanliness concerns arise.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 is a front perspective view of a travel caddy, according to one embodiment of the present invention.

FIG. 2 is an exploded back plan view of a travel caddy, showing the placement of the couplers which top hook the caddy to a pocket on the backside of a vehicle seat, according to one embodiment of the present invention.

FIG. 3 is a back plan view of a travel caddy, according to one embodiment of the present invention.

FIG. 4 is a front plan view of a travel caddy, folded, according to one embodiment of the present invention.

FIG. 5 is a cross-sectional view of the travel caddy coupled with a seatback pocket according to one embodiment of the present invention.

FIGS. 6 and 7 respectively illustrate perspective and side views of a coupler according to one embodiment of the present invention.

### DETAILED DESCRIPTION

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

When traveling, particularly, with infants and small children, several items such as diapers, toys, books, bottles and pacifiers are needed close at hand throughout the course of a trip. For adults, books, bottled beverages, reading glasses and cellular phones are often desired within arm's reach. Embodiments of the present invention provide a travel caddy that allows simple, one-handed access to one's belongings. The travel caddy, as will be described hereinafter, is provided in a format that hangs close to the airplane or car seat, increasing leg room. In various embodiments, the travel caddy may then be folded to a compact size to fit easily into larger carrying bags.

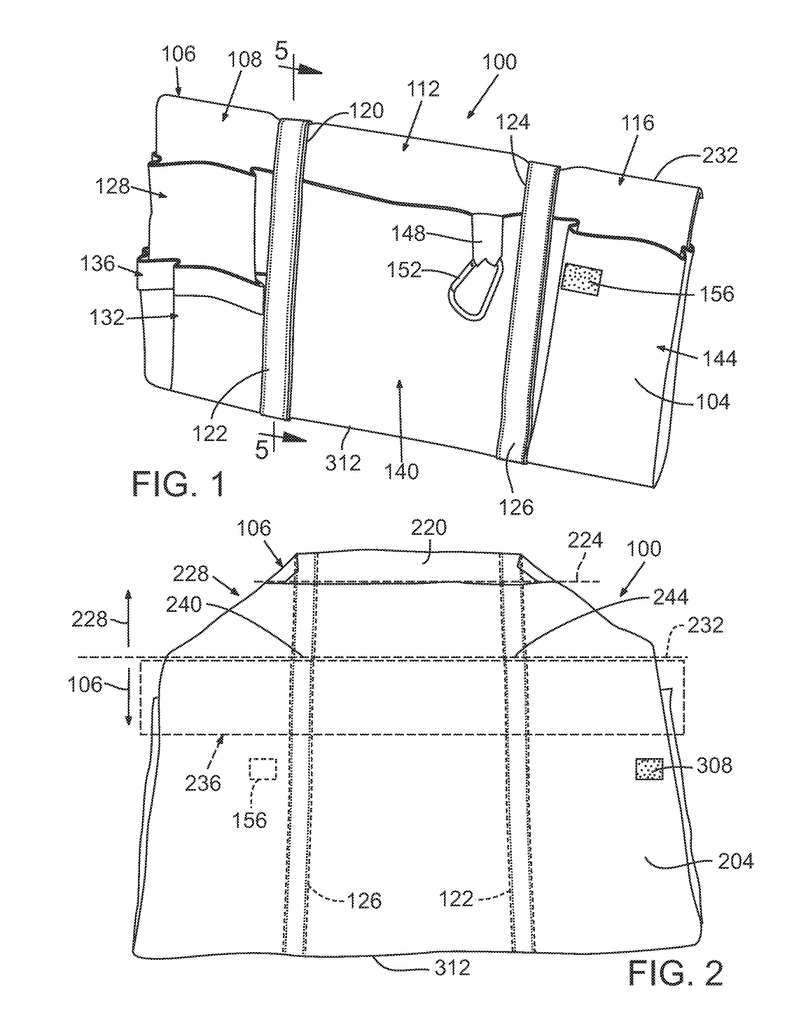

FIG. 1 is a front perspective view of a travel caddy 100 in accordance with some embodiments. FIG. 1 shows, in particular, a front side 104 of the travel caddy 100. The travel caddy 100 may include a three-panel structure 106 with a first panel 108, a second panel 112, and third panel 116. While the travel caddy 100 is shown with the three-panel structure 106 in FIG. 1, other embodiments may include a panel structure with another number of panels.

The second panel 112 may be coupled with the first panel 108 at a first edge 120. The second panel 112 may be coupled with the first panel 108 in a manner that facilitates rotation of the first panel 108 with respect to the second panel 112 around a joint 122.

The second panel 112 may also be coupled with the third panel 116 at a second edge 124, which is opposite the first edge 120. The third panel 116 may be coupled with the second panel 112 in a manner that facilitates rotation of the third panel 116 with respect to the second panel 112 around a joint 126.

The panels of the travel caddy 100 may be constructed of a flexible, durable material such as canvas, vinyl, leather or any other materials or fabrics that are known in the art as suitable for making such a travel caddy 100. It is also possible for the travel caddy 100 to be made from a combination of materials having different properties such as durability, water-resistance, flexibility and the like. In some embodiments, one or more of the panels of the travel caddy 100 may have a supportive substrate, for example, plastic, cardboard, paperboard, etc., disposed within the panel for structural support.

Each of the panels of the travel caddy 100 may include one or more pockets fixedly coupled with the front side 104 of the travel caddy 100.

Fixedly coupled, as used herein, may refer to a coupling that is not intended to be reversed or undone in the normal course of use of the travel caddy 100. Fixed coupling may be performed by sewing, gluing, etc.

In the embodiment shown, the first panel 108 may include three pockets, e.g., pockets 128, 132, and 136; the second panel 112 may include pocket 140; and the third panel may include pocket 144. The pockets may be designed to hold various travel essentials, such as books, water bottles, mobile phones and snacks, or baby essentials such as diapers, bottles, sippy cups, toys and pacifiers. In various embodiments, pockets may be specifically-designed to hold any of a variety of items. For example, the pocket 136 may be specifically-designed to hold a writing instrument.

In some embodiments, the pockets may be constructed of a material that is similar to a material used in the construction of the panels; however, in other embodiments, other materials may be used. For example, the pockets may be constructed of a mesh or clear plastic. Such construction may allow for a user to visually identify the contents of the pockets.

The second panel 112 may include an attachment point 148 to accommodate a loop fastener, for example, carabiner 152.

The third panel 116 may include a fastener 156. The fastener 156 may be positioned, as shown in FIG. 1, on the outside of the pocket 144. As will be described below, the fastener 156 may be used to hold the travel caddy 100 in a folded state.

FIG. 2 is an exploded back plan view of the travel caddy 100 in accordance with an embodiment. FIG. 2 shows, in particular, a backside 204 of the travel caddy 100.

The travel caddy 100 may include couplers, e.g., coupler 208 shown in FIGS. 6 and 7, which are integrated within, or fixedly coupled with, the three-panel structure 106, which may be generally considered the portion below fold line 232, and a hook section 228, which may be generally considered the portion above the fold line 232, at joints 122 and 126. The couplers may extend, through respective joints, partially or fully to a bottom edge 312 of the travel caddy 100.

The couplers may be semirigid couplers made of a material such as, metal, plastic, or any another type of suitable material.

Construction of the travel caddy 100 may include fixed coupling of a backside material, shown generally in FIG. 2, to a frontside material shown generally in FIG. 1. The hook section 228 may be folded over the fold line 232 and may thereafter obscure covered section 236. The couplers may then be inserted between the frontside material and the backside material in the joints 122 and 126. Top bends of the couplers, e.g., bend 212 shown in FIG. 7, may be positioned at points 240 and 244. A top tab 220 may then be folded over a fold line 224 and fixedly coupled to the underside of the hook section 228.

The hook section 228 may not be coupled with the covered section 236. Rather, the hook section 228 may be held against the covered section 236 due to deformation properties of the couplers. In particular, elastic deformation properties of the couplers at points 240 and 244 may provide a spring-like force holding the hook section 228 against, or adjacent to, the covered section 236.

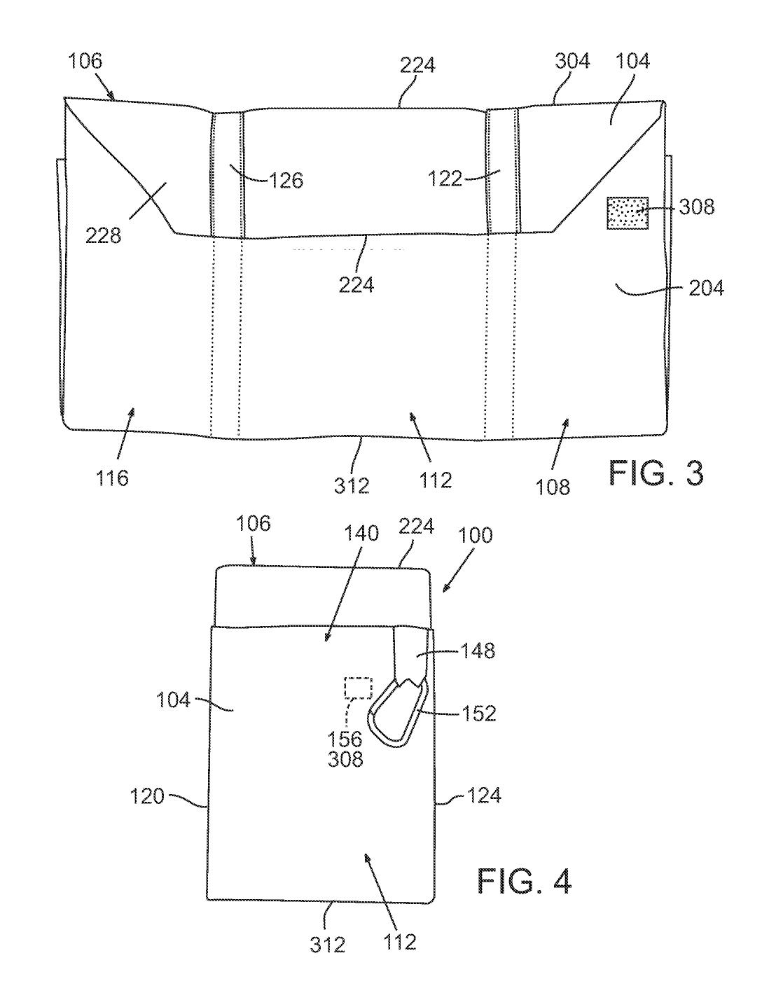

FIG. 3 is a back plan view of the travel caddy 100 in accordance with an embodiment. A top edge 304 of the travel caddy 100 generally corresponds to the fold line 232. The top edge 304 may also be considered as a coupling location of the hook section 228 and the three-panel structure 106.

FIG. 3 also shows a fastener 308 on first panel 108. The fastener 308 may complement the fastener 156 of third panel 116 shown in FIG. 1. The fasteners 156 and 308 may be configured to reversibly couple with one another, i.e., couple with one another in a manner that accommodates routine separation and re-coupling. The fasteners 156 and 308 may be, but are not limited to, hook-and-loop fasteners, snap fasteners, button fasteners, and magnetic fasteners. In some embodiments, the fasteners 156 and 308 may not be included in the travel caddy 100, or their placement on the three-panel structure 106 may be adjusted to facilitate easier folding of the travel caddy 100 when detached from the seatback pocket.

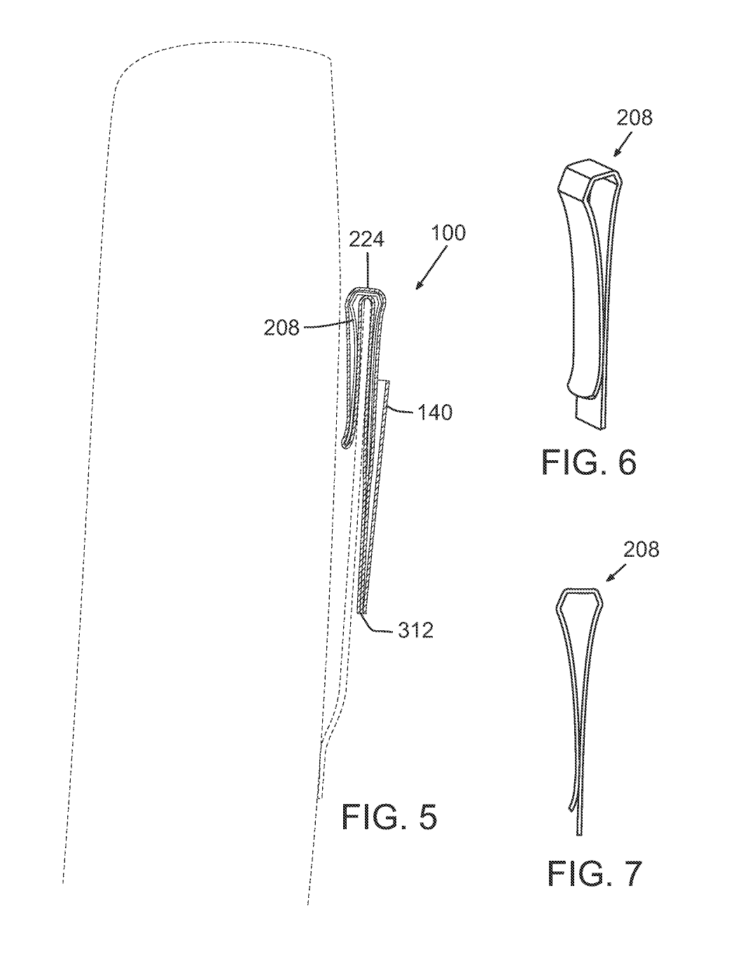

The couplers of the travel caddy 100 may be configured to top-hook a seatback pocket with the hook section 228 being disposed within the vehicle pocket as is shown in the cross-section view of the travel caddy 100 in FIG. 5. In this manner, a user may easily couple and decouple the travel caddy 100 with/from the seatback pocket. Further, the structure and deformation properties of the couplers may result in the couplers providing a transverse force rotating the bottom edge 312 of the three-panel structure 106 toward the seatback pocket. Rotating the bottom edge 312 toward the seatback pocket, rather than allowing it to hang vertically from a coupling point at the top edge of the seatback pocket, increases legroom for an occupant of a seat directly behind the seatback pocket. It may also be noted that this transverse force is provided solely by the top-hook arrangement, without relying on attachment points at bottom of the three-panel structure 106, which may inhibit removal of the travel caddy 100 from the seatback pocket.

FIG. 4 illustrates the travel caddy 100 in a folded state in accordance with an embodiment. Once removed from a seatback pocket, the travel caddy 100 may be folded at the joints 122 and 126, and the fasteners 156 and 308 may be reversibly coupled with one another. The folded arrangement of the travel caddy 100 may allow for compact transport within larger carrying bags.

In some embodiments, the travel caddy 100 may be relatively small to facilitate one-handed manipulation. In some embodiments, the travel caddy 100 may have a height of less than nine inches and a width of less than seventeen inches.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims and the equivalents thereof.

What is claimed is:

1. An article of manufacture comprising:
a panel structure having a first side and a second side, the panel structure including a first panel coupled with a second panel in a manner that facilitates rotation of the first panel with respect to the second panel, the first panel including a first pocket and the second panel including a second pocket, the first pocket and the second pocket being located on the first side of the panel structure; and
a coupler rigidly coupled with, or integrated within, the panel structure and configured to top hook a seatback pocket.

2. The article of manufacture of claim 1, wherein the first panel is coupled with the second panel at a first edge, the first panel further includes a second edge opposite the first edge, and the article of manufacture further comprises:
a third panel coupled the first panel at the second edge, the third panel including a third pocket.

3. The article of manufacture of claim 2, wherein the third panel is coupled with the second edge of the first panel in a manner that facilitates rotation of the third panel with respect to the first panel.

4. The article of manufacture of claim 3, further comprising:
a fastener configured to reversibly couple the second panel with the third panel when the article of manufacture is in a folded state.

5. The article of manufacture of claim 3, wherein the first panel is coupled with the second panel at a first joint, the first panel is coupled with the third panel at a second joint, the coupler is a first coupler coupled with, or integrated within, the first joint, and the article of manufacture further includes:
a second coupler, coupled with, or integrated within, the second joint, and configured to top hook the seatback pocket in conjunction with the first coupler.

6. The article of manufacture of claim 1, wherein the panel structure includes a first edge and a second edge that is opposite the first edge, wherein the coupler is configured to top hook the seatback pocket at the first edge and to provide a transverse force to rotate the second edge toward the seatback pocket.

7. The article of manufacture of claim 1, wherein the panel structure includes a height of less than nine inches and a width of less than seventeen inches.

8. A method of manufacturing a travel caddy comprising:
fixedly coupling a backside material to a frontside material;
folding a hook portion of the travel caddy over a fold line;
inserting first and second couplers between the backside and frontside materials, wherein the first and second couplers are disposed at first and second joints and are configured to facilitate a top-hook coupling of the travel caddy to a seatback pocket; and
fixedly coupling one or more pockets to a frontside of the travel caddy.
